(19) United States
(12) Patent Application Publication
(10) Pub. No.: US 2002/0190141 A1
(43) Pub. Date: Dec. 19, 2002

(54) Pistol nozzle

(76) Inventor: Huang Fu Huang, Fengyuan Hsiang (TW)

Correspondence Address: ROSENBERG, KLEIN & LEE, 3458 ELLICOTT CENTER DRIVE-SUITE 101, ELLICOTT CITY, MD, 21043, US

(21) Appl. No.: 09/883,286

(22) Filed: Jun. 19, 2001

(51) Int. Cl. B05B 7/02

(52) U.S. Cl. 239/526; 239/538; 239/540

(57) ABSTRACT

A pistol nozzle is constructed to include a body, a cap covered on the body, a spray-pattern disc and a spray-pattern dial fastened together and coupled to the cap, and a control ring for rotating the spray-pattern disc and the spray-pattern dial to control the spray pattern of water, the spray-pattern dial having a smoothly arched water hole disposed in communication with one water outlet of the spray-pattern disc for output of water from the body to produce a wide spray pattern of water.

### BACKGROUND OF THE INVENTION

The present invention relates to a water spraying apparatus and, more specifically, to such a pistol nozzle that can be controlled to output a wide spray pattern of water to wet a broad area at low water pressure.

A conventional pistol nozzle, as shown in FIG. 1, comprises a body 1′, the body 1′ comprising a mounting shaft 2′ and a water outlet tube 3′; a cap 4′ fixedly fastened to the body 1′, the cap 4′ comprising a center coupling hole 5′ coupled to the mounting shaft 2′ of the body 1′ and a water outlet 6′ connected to the water outlet tube 3′ of the body 1′ for output of water; a spray-pattern disc 13, the spray-pattern disc 13 comprising a center coupling hole 14 coupled to the mounting shaft 2′ of the body 1′ and a series of water outlets 16 and a water seal portion 17 equiangularly spaced around the center coupling hole 14 of the spray-pattern disc for selectively receiving water from the water outlet 6′ of the cap 4′ or closing the water outlet 6′ of the cap 4′; a spray-pattern dial 10 fastened to the spray-pattern disc 13 and rotatably supported on the mounting shaft 2′ of the body 1′, the spray-pattern dial 10 comprises a center coupling hole 140 coupled to the mounting shaft 2′ of the body 1′, and a plurality of water outlets 11 of different patterns and a water seal portion 12 corresponding to the water outlets 16 and water seal portion 17 of the spray-pattern disc 13. This structure of pistol nozzle is still not satisfactory in function. The main drawback of this structure of pistol nozzle is that the water outlets 11 of the spray-pattern dial 10 cannot produce a wide spray pattern of water to wet a broad area efficiently. Another drawback of this structure of pistol nozzle is that the spray pattern of water outputted through either of the water outlets 11 of the spray-pattern dial 10 has a high water pressure that may damage the plants.

### SUMMARY OF THE INVENTION

The present invention has been accomplished to provide a pistol nozzle, which eliminates the aforesaid drawbacks. It is one object of the present invention to provide a pistol nozzle that can be controlled to produce a wide spray pattern of water for wetting a broad area efficiently. It is another object of the present invention to provide a pistol nozzle that can be controlled to produce a wide spray pattern of water of low water pressure for wetting plants in a broad efficiently without causing damage to the plants. To achieve these and other objects of the present invention, the pistol nozzle is constructed to include a body, a cap covered on the body, a spray-pattern disc and a spray-pattern dial fastened together and coupled to the cap, and a control ring for rotating the spray-pattern disc and the spray-pattern dial to control the spray pattern of water, wherein the spray-pattern dial has a smoothly arched water hole disposed in communication with one water outlet of the spray-pattern disc for output of water from the body to produce a wide spray pattern of water of low water pressure for wetting a broad area efficiently.

### BRIEF DESCRIPTION OF THE DRAWINGS

FIG. 1 is an exploded view of a pistol nozzle according to the prior art.

FIG. 2 is an exploded view of a pistol nozzle according to the present invention.

FIG. 2A is an oblique rear elevation of the spray-pattern dial of the pistol nozzle shown in FIG. 2.

FIG. 2B is an enlarged view of a part of FIG. 2A.

FIG. 3A is a sectional assembly view in an enlarged scale of the pistol nozzle shown in FIG. 2.

FIG. 3B is a front view of FIG. 3A.

FIG. 4 shows a spray patter of water driven out of the smoothly arched water hole of the spray-pattern dial according to the present invention.

FIG. 5 is an elevational view of an alternate form of the spray-pattern disc according to the present invention.

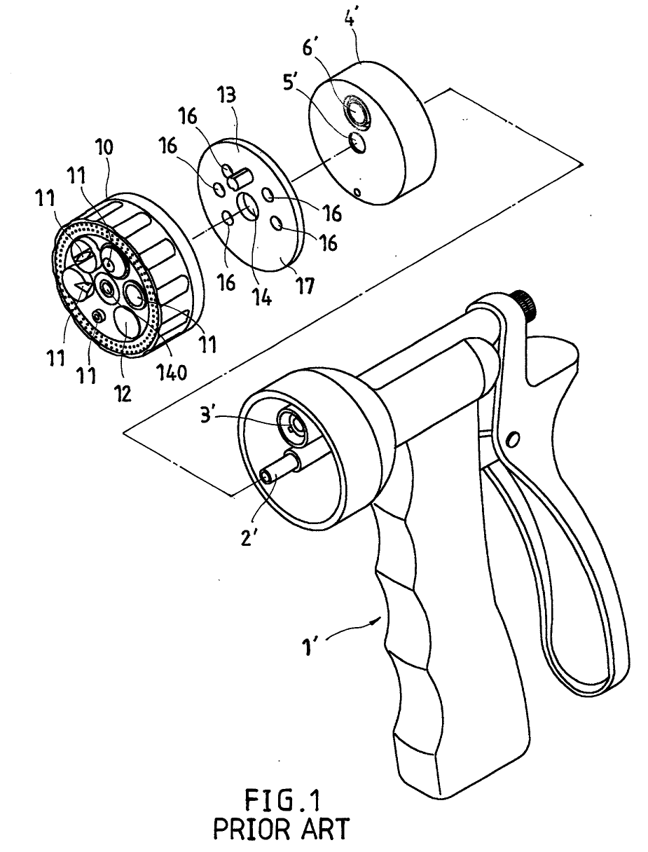

### DETAILED DESCRIPTION OF THE PREFERRED EMBODIMENT

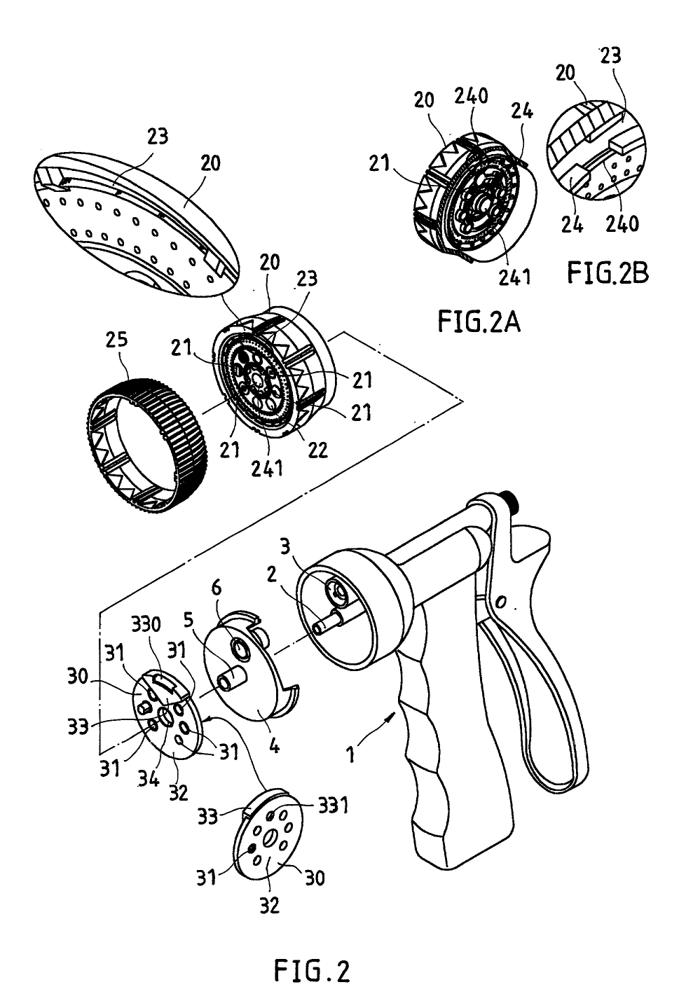

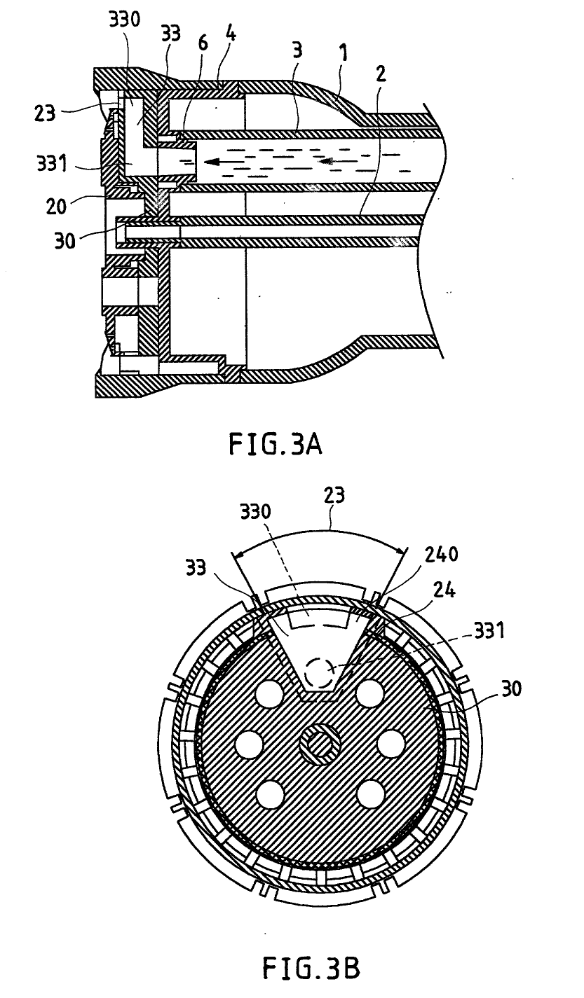

Referring to FIGS. 2 and 3, a pistol nozzle is shown comprised of a body 1, a cap 4, a spray-pattern disc 30, a spray-pattern dial 20, and a control ring 25. The body 1 comprises a mounting shaft 2 and a water outlet tube 3. The cap 4 is fixedly fastened to the front side of the body 1, comprising a center coupling tube 5 coupled to the mounting shaft 2 of the body 1 and a water outlet 6 connected to the water outlet tube 3 of the body 1. The spray-pattern disc 30 is rotatably supported on the center coupling tube 5 of the cap 4, comprising a center coupling hole 34 coupled to the center coupling tube 5 of the cap 4 and a series of water outlets 31 and a water seal portion 32 equiangularly spaced around the center coupling hole 34. The spray-pattern dial 20 is fastened to the spray-pattern disc 30 for synchronous rotation with the spray-pattern disc 30 on the center coupling tube 5 of the cap 4, comprising a center coupling hole 241 coupled to the center coupling tube 5 of the cap 4 and a series of water outlets 21 of different patterns corresponding to the water outlets 31 of the spray-pattern disc 30. The control ring 25 is fastened to the spray-pattern dial 20 for operation by hand to rotate the spray-pattern dial 20 and the spray-pattern disc 30 on the center coupling tube 5 of the cap 4 to alternatively aim the water outlets 21 of the spray-pattern dial 20 and the water outlets 31 of the spray-pattern disc 30 at the water outlet 6 of the cap 4. The aforesaid structure is similar to a conventional pistol nozzle. The main features of the present invention are outlined hereinafter.

The spray-pattern dial 20 comprises a smoothly arched water hole 23 extended along the border area of the front side thereof, an inner sealing flange 24 stopped against the spray-pattern disc 30, an opening 240 cut through the inner sealing flange 24 in communication with the smoothly arched water hole 23. The spray-pattern disc 30 comprises a bottom chamber 33, and an opening 330 in communication between the bottom chamber 33 and the opening 240 of the spray-pattern dial 20. The water outlets 31 of the spray-pattern disc 30 includes one 331 in communication with the bottom chamber 33.

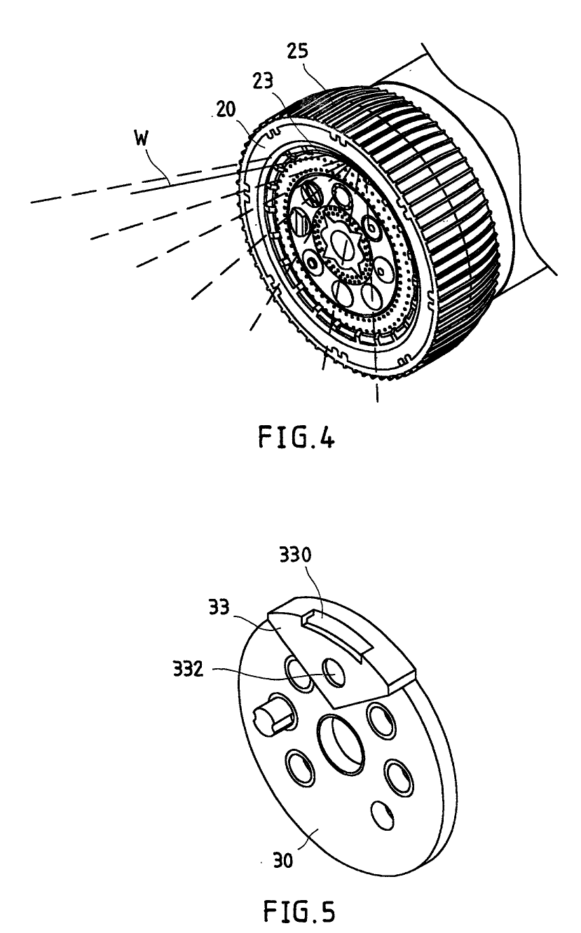

Referring to FIGS. 3 and 4, when operating the control ring 25 to rotate the spray-pattern dial 20 and the spray-pattern disc 30 and to let the water outlet 331 of the spray-pattern disc 30 be aimed at the water outlet 6 of the cap 4. At this time, water flows from the water outlet tube 3 through the water outlet 6 of the cap 4 to the bottom chamber 33 of the spray-pattern disc 30 via the water outlet 331, and then flows from the bottom chamber 33 through the opening 240 to the outside of the pistol nozzle through the smoothly arched water hole 23. Because the water hole 23 is a narrow, elongated, smoothly arched water output hole, the spray pattern of water W covers a broad area (see FIG. 4). Further, because the spray pattern of water W is not a wide spray of fine drops of water but not a strong stream of water, the pressure of water is low. When sprayed over flowers, plants, or earth, no damage is made to the object receiving the water. Further, when rotating the control ring 25 to move the spray-pattern dial 20 and the spray-pattern disc 30 to such a position that the water seal portion 22 of the spray-pattern dial 20 and the water seal portion 32 of the spray-pattern disc 30 are aimed at the water outlet 6 of the cap 4, the water outlet 6 of the cap 4 is sealed, and the pistol nozzle is closed.

FIG. 5 shows an alternate form of the spray-pattern disc 30. According to this alternate form, the spray-pattern disc 30 comprises a bottom chamber 33, an opening 330 in communication between the bottom chamber 33 and the opening 240 of the spray-pattern dial 20, and a front water outlet 332 aimed at one water outlet 21 of the spray-pattern dial 20.

A prototype of pistol nozzle has been constructed with the features of FIGS. 2˜5. The pistol nozzle functions smoothly to provide all of the features discussed earlier.

Although a particular embodiment of the invention has been described in detail for purposes of illustration, various modifications and enhancements may be made without departing from the spirit and scope of the invention. Accordingly, the invention is not to be limited except as by the appended claims.

What the invention claimed is:

1. A pistol nozzle comprising:
a body, said body comprising a mounting shaft and a water outlet tube;
a cap fixedly fastened to said body, said cap comprising a center coupling tube coupled to the mounting shaft of said body and a water outlet connected to the water outlet tube of said body for output of water;
a spray-pattern disc rotatably supported on the center coupling tube of said cap, said spray-pattern disc comprising a center coupling hole coupled to the center coupling tube of said cap and a series of water outlets and a water seal portion equiangularly spaced around the center coupling hole of said spray-pattern disc for selectively receiving water from the water outlet of said cap;
a spray-pattern dial fastened to said spray-pattern disc for synchronous rotation with said spray-pattern disc on the center coupling tube of said cap, said spray-pattern dial comprising a center coupling hole coupled to the center coupling tube of said cap and a series of water outlets of different patterns corresponding to the water outlets of said spray-pattern disc; and
a control ring fastened to said spray-pattern dial for operation by hand to rotate said spray-pattern dial and said spray-pattern disc on the center coupling tube of said cap and to alternatively aim the water outlets of said spray-pattern dial and the water outlets of said spray-pattern disc at the water outlet of said cap; wherein:
said spray-pattern dial comprises a smoothly arched water hole extended along the border area of a front side thereof, an inner sealing flange stopped against said spray-pattern disc, an opening cut through said inner sealing flange in communication with said smoothly arched water hole; said spray-pattern disc comprises a bottom chamber adapted to receive water from the water outlet of said cap through one water outlet of said spray-pattern disc, and an opening in communication between said bottom chamber and the opening of said spray-pattern dial.

2. The pistol nozzle of claim 1 wherein said spray-pattern disc comprises a front water outlet aimed at one water outlet of said spray-pattern dial for output of water.
